(19) United States
(12) Patent Application Publication
(10) Pub. No.: US 2006/0152995 A1
(43) Pub. Date: Jul. 13, 2006

(54) Apparatus for delivering and recirculating liquid compositions

(76) Inventor: Charles Kreutzer, Springfield, IL (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/031,863

(22) Filed: Jan. 7, 2005

(51) Int. Cl. C04B 16/00; B28C 7/04

(52) U.S. Cl. 366/8; 106/712; 417/36; 417/42

(57) ABSTRACT

An apparatus and a method are provided for continuously pumping liquid coloring composition to a destination without interruption in flow. This allows all loads delivered to multiple mixing chambers, for concrete, cement or the like, to be uniform, such that the resultant colors of the poured materials are uniform in color when compared to each other. The apparatus also includes a system for recirculating liquid coloring composition so as to reduce its viscosity such that it is of lower viscosity and therefore, flowable for pumping to the desired destination.

### TECHNICAL FIELD

The present invention relates generally to apparatus and methods for the production of colored concrete, cement, and other similar materials. In particular, the invention is directed to systems and apparatus for continuously delivering amounts of liquid coloring compositions, typically for cementicious materials, such as concrete, to mixing chambers thererfor, so that all sections of the poured concrete for a job are uniform in color to each other.

### BACKGROUND

Concrete has long been a staple in the construction industry. As concrete technology increases, more uses are found for it, including coloring concrete while it is being mixed. By coloring concrete in the mixing stage, its coloration is permanent and does not require painting, that otherwise, must be done periodically. Also, concrete colored in this manner wears uniformly, as the coloration is consistent throughout the entire concrete section or slab.

Uses for colored concrete are rapidly expanding, due to its economical cost and durability. For example, colored concrete that is stamped is replacing brick and stone walkways. Additionally, colored concrete floors are appearing in supermarkets, big-box, warehouse, and other large commercial outlets, replacing the traditional tiled, wood or carpeted floors. These colored concrete floors do not require the maintenance and upkeep, compared to that for the conventional tiled, wood or carpeted floors.

These walkways and floors are produced from concrete pourings. The concrete pourings are typically from multiple ready-mix trucks, each pouring defining a section or slab of the walkway or floor. Each section (slab) must be consistent and of uniform color, with all other sections (slabs), so that the job, for example, the walkway or floor, is of a uniform color. Otherwise, the walkway or floor will look inconsistent, resulting in the job being rejected. This forces the concrete contractor to suffer losses of money and goodwill, and they are usually forced to repeat the job at their expense.

### SUMMARY

The present invention improves on the contemporary art by providing an apparatus and a method for continuously delivering liquid coloring composition to a destination, typically by pumping, without interruption in flow. By continuously delivering liquid coloring composition at a constant or steady flow, the amount of coloring composition delivered to each mixing chamber for concrete, for example, a ready mix truck, can be monitored so as to be uniform for all mixing chambers. As a result, all poured concrete sections or slabs of the job will be of a uniform color with respect to each other.

The present invention also recirculates liquid compositions, for example, liquid coloring compositions, as commonly stored in tanks. These liquid coloring compositions, as a result of their being stored in a tank, may have become gelatinous and accordingly, highly viscous. They may need to be recirculated, to decrease their viscosity and render them of lower viscosity so as to be flowable and thus, easily delivered from a pump to the desired destination. This recirculation is typically performed prior to pumping the liquid composition to the desired destination, and may be repeated for as many cycles as desired, until the liquid composition is at a desired flowable viscosity for pumping to the desired destination.

The present invention also provides an apparatus that is portable. It can be moved from job to job as a single unit, without any need for disassembly and the like. The apparatus can deliver a single color of a liquid composition, from a tank or other source of colorant, efficiently and economically.

An embodiment of the invention is directed to a method for delivering colorant to concrete, to produce uniformly colored concrete batches. The method includes obtaining liquid coloring composition from at least one source of coloring composition, determining the amount of the liquid coloring composition for uniformly coloring at least one batch of concrete with respect to at least one other batch of colored concrete, and delivering the liquid coloring composition into a mixing chamber for mixing and coloring at least one batch of concrete in the mixing chamber. The delivering includes pumping the liquid coloring composition into the mixing chamber along a flow pathway from the at least one source to the mixing chamber. The delivery of the liquid composition is monitored, such that the amount of liquid coloring composition delivered is at least substantially equal to the determined amount of liquid coloring composition.

Another embodiment of the invention is directed to a method for delivering colorant to concrete. The method includes, obtaining at least a predetermined amount of liquid coloring composition, the predetermined amount of liquid coloring composition for uniformly coloring at least one batch of concrete with respect to at least one other batch of colored concrete, and delivering the liquid coloring composition into a mixing chamber for mixing with a batch of concrete. The delivering includes providing a first pump for pumping the liquid coloring composition. The first pump is monitored to determine if the delivering of the liquid coloring composition is continuous.

Another embodiment of the invention is directed to an apparatus for delivering a liquid composition to a predetermined site. The apparatus includes a first pump configured for drawing liquid composition from a source of liquid composition and pumping the liquid composition along a flow pathway from a source of liquid composition to a discharge opening, the first pump including a motor. There is also a controller in electrical communication with the motor of the first pump, the controller configured for controlling operation of the motor of the first pump, and there is at least one first sensor configured for sensing the flow of liquid composition along the flow pathway. This first sensor is in electrical communication with the motor and the controller.

Another embodiment of the invention is directed to an apparatus for delivering a liquid composition to a predetermined site. The apparatus includes, a vessel, for example, a tank, for holding liquid composition, and a first pump in communication with the vessel, the first pump for drawing liquid composition from the vessel and pumping the liquid composition along a flow pathway from the vessel to a predetermined location, the first pump including a motor. There is also a controller in electrical communication with the motor of the first pump, and, there is a first sensor configured for sensing the flow of liquid composition along the flow pathway, the first sensor in electrical communication with the motor and the controller.

Still another embodiment of the invention is directed to an apparatus for delivering a liquid composition to a predetermined site. The apparatus includes at least one first pump including a motor and a tank in communication with the at least one first pump. There is a controller in electrical communication with the motor, the controller configured for controlling operation of the motor, and, a first sensor configured for sensing liquid volume in the tank, the first sensor in electrical communication with the motor and the controller.

### BRIEF DESCRIPTION OF THE DRAWINGS

Attention is now directed to the drawing figures, wherein like reference numerals or characters indicate corresponding or like components. In the drawings:

FIG. 1 is a perspective view showing an apparatus in accordance with an embodiment of the present invention in an exemplary operation;

FIG. 2 is a schematic diagram of the apparatus of FIG. 1;

FIG. 3 is a side view of the apparatus of FIG. 1;

FIG. 4 is a side view of the apparatus of FIG. 1, with the tank and its frame removed from the apparatus;

FIG. 5 is a top view of the apparatus of FIG. 1, with the tank and its frame removed from the apparatus;

FIG. 6 is a front view of the inside of a cabinet with its cover removed, to show the air system, the water system, and water lines of the apparatus;

FIG. 7 is a front view of the front panel of the control box that houses the control panel for the apparatus;

FIGS. 8-11 are screen shots from the Programmable Logic Control (PLC) of the apparatus;

FIG. 12 shows the apparatus of the invention with an auxiliary unit stacked on top of it in accordance with another embodiment of the invention;

FIG. 13 is a perspective view of the apparatus of the invention performing a recirculation operation in accordance with another embodiment of the invention;

FIG. 14 is a perspective view of the apparatus of the invention in use with a laterally positioned auxiliary tank in accordance with another embodiment of the invention; and

FIGS. 15A and 15B are a flow diagram for a process in accordance with an embodiment of the invention.

### DETAILED DESCRIPTION OF THE DRAWINGS

The present invention provides apparatus and methods for continuously delivering liquid compositions, for example, liquid coloring composition, to a destination, by pumping, without interruption in flow. This continuous flow can be monitored such that uniform volumes of the liquid composition are provided to each destination, typically mixing chambers, to which the liquid composition is pumped.

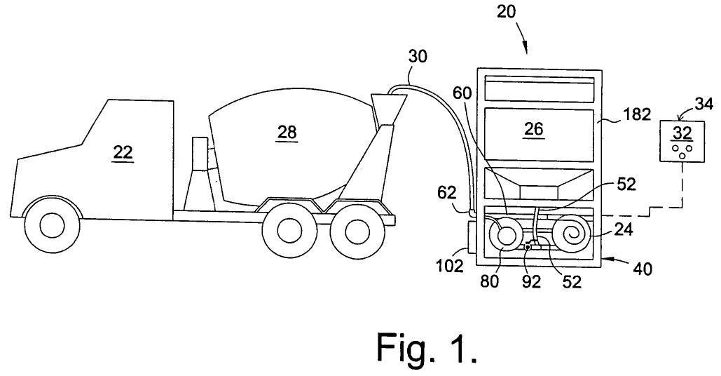

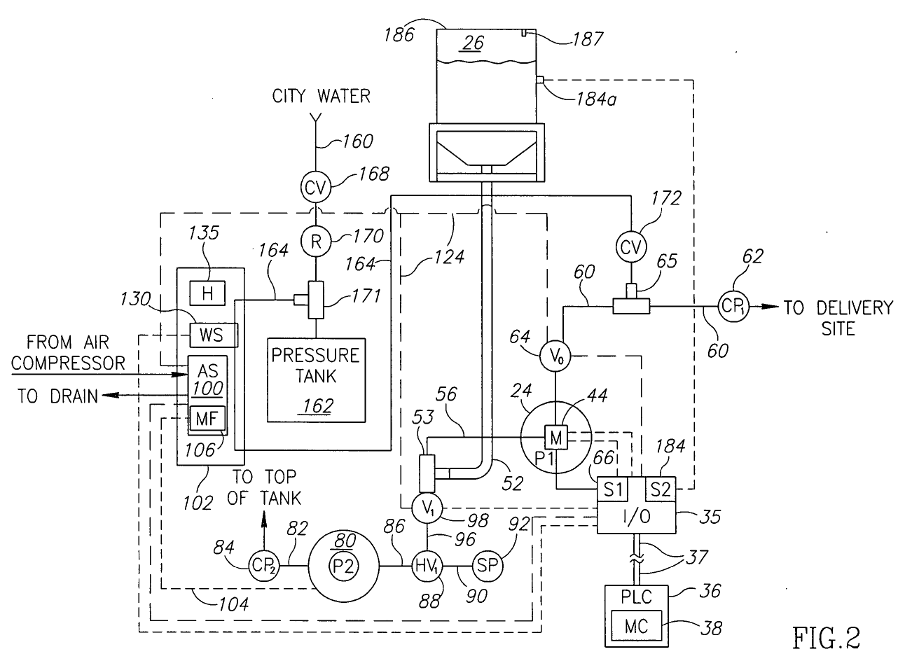

FIG. 1 shows the apparatus 20 of the present invention in an exemplary operation. As shown in FIG. 1, and also referring to FIG. 2, the apparatus 20 is shown delivering liquid coloring composition for concrete, cement or the like, into a ready-mix truck 22. Specifically, a main pump (P1) 24 of the apparatus 20 delivers the liquid coloring composition from a tank 26 (commonly referred to as a tote) or other source, into the mixing chamber 28 of the ready mix truck 22, over a discharge line 30. The mixing chamber 28 of the ready-mix truck 22 is typically at a higher elevation than the discharge point of the main pump (P1) 24 (where the liquid coloring composition leaves the apparatus 20). The mixing chamber 28 typically includes a batch of concrete, corresponding to a number of yards to be poured. The mixing chamber 28 is rotating at speeds in accordance with each manufacturers' specification, such that when the liquid coloring composition enters the mixing chamber 28, it is dispersed into the concrete. For example, a McNeilus® mixing chamber, rotates at the speed of approximately 18 rpm to approximately 20 rpm.

A control panel 32, that is part of a protective (e.g., water-tight) cabinet 34, typically the front cover, is positioned on or near (e.g., within a few meters of) the apparatus 20. Some functions of the apparatus 20 are controllable through this control panel 32, such as stopping and starting the apparatus 20. An Input/Output (I/O) device 35 is inside the cabinet 34, and in electronic communication, by wired or wireless links, with the control panel 32 and the apparatus 20 (components and systems of the apparatus 20), as shown in broken lines.

The I/O device 35 is electronically connected, by wired or wireless links to a programmable logic controller (PLC) 36, for example, over an Ethernet cable 37. The PLC 36 includes a main controller (MC) or controller 38 for the apparatus 20. The components for the apparatus 20, described herein, are electronically linked to the I/O device 35, and accordingly, electronically linked (by wired or wireless links) to the main controller (MC) 38, so that all components and systems of the apparatus 20 are controllable by the PLC 36. The operation of the control panel 32, I/O device 35, PLC 36, and main controller (MC) 38 are detailed further below.

The liquid coloring compositions, as described herein, are typically used for coloring cementicious materials, including, concrete, cement, or the like. Liquid coloring compositions suitable for use with the apparatus 20 include, liquid colorants, pigments, coloring agents, colors, and the like. For example, a suitable liquid coloring composition is CF 413 Red, available from Solomon Colors, Inc., Springfield, Ill. The liquid coloring compositions may include additives, already in the liquid coloring composition in the tank 26, or prepackaged, and added while in the tank 26, along the flow pathway of the apparatus 20, or in the mixing chamber 28. While the mixing chamber 28 of a ready mix truck 22 is shown, any other mixing chamber is also suitable for use with apparatus 20.

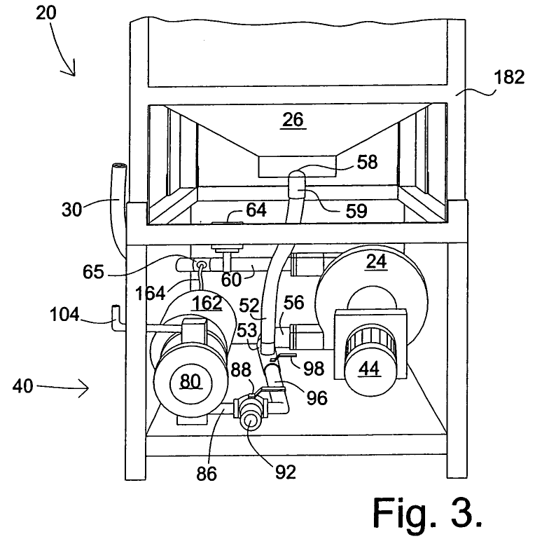

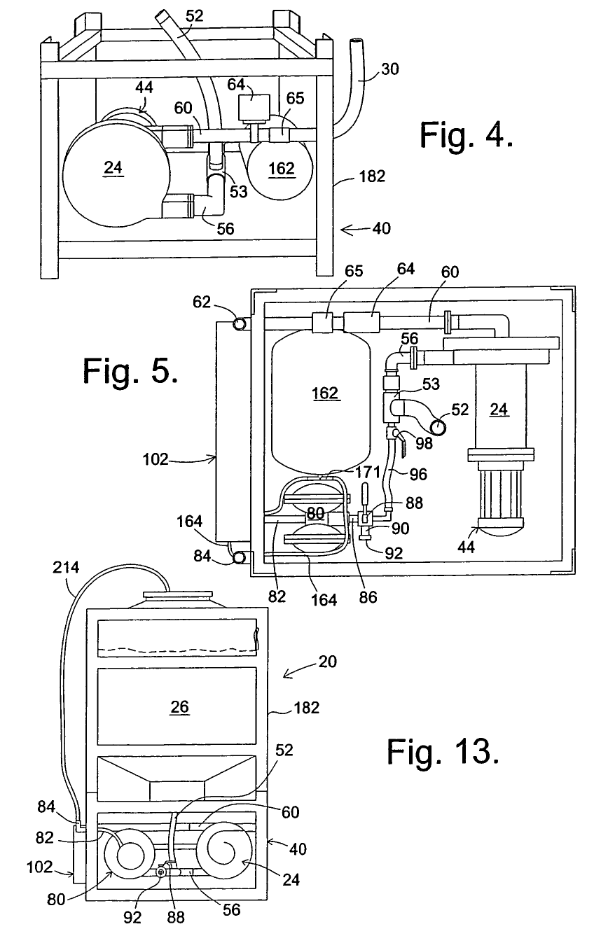

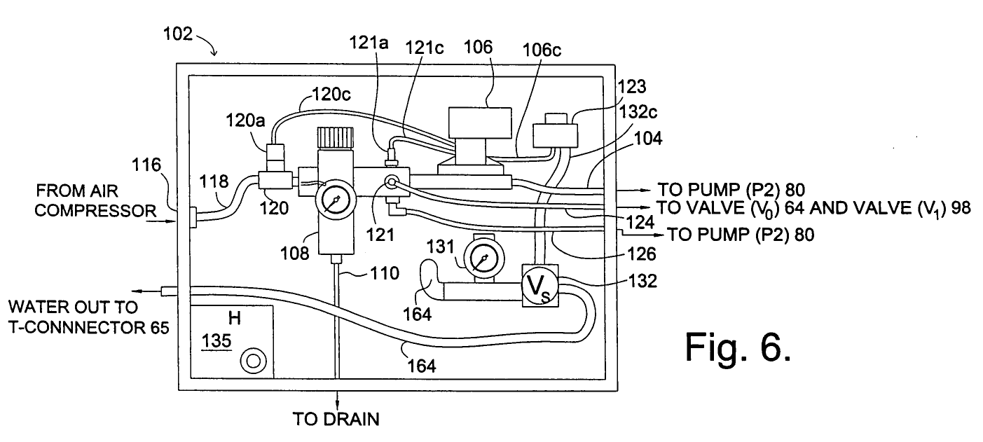

Attention is now also directed to FIGS. 3-5. In FIGS. 3-5, liquid lines, electrical connections, air and water lines, may only be shown partially, if at all. Accordingly, reference should be made to the schematic diagram of FIG. 2, to show the requisite liquid lines, electrical connections (shown in short broken lines), air lines (shown in long broken lines) and water lines, and their respective connections in the apparatus 20.

The base 40 supports the main pump (P1) 24, that pumps liquid compositions, here liquid coloring composition, to the delivery destination, typically over the discharge line 30. The main pump (P1) 24 is controlled by a motor (M) 44, that is in turn, controlled by the main controller (MC) 38. The main pump (P1) 24 is typically a self metering pump, and is, for example, a peristaltic pump (that operates in pulses, each pulse of a defined volume). However, metering equipment, measuring and monitoring equipment, and the like, may be used anywhere in the apparatus 20, for example, along the pump outflow line 60, to monitor operation of the main pump (P1) 24.

The main pump (P1) 24 is such that it can deliver liquid compositions to locations spaced apart from the apparatus 20 and at elevations above or below the point at where the liquid composition is being discharged from the apparatus 20. For example, one peristaltic pump that is used with the apparatus 20 as the main pump (P1) 24, is a Pump Model SP-32 from Watson-Marlow. Other pumps may include the pump models SP-15 and SP-25 from Watson-Marlow. Additional suitable pumps for this main pump (P1) 24 include metering pumps, such as piston pumps, that put out at constant volumes, to have a defined output, and that can be monitored.

A hose 52 connects to a T-connector 53, that is connected to an inflow line 56 of the main pump (P1) 24. The other end of the hose 52 connects to the tank 26 at its lower opening 58 through a discharge fitting 59. The tank 26 is at an elevation above the main pump (P1) 24, such that material can be gravity fed into the main pump (P1) 24 (typically creating head pressure and completely filling the pump cavities, for example, in the peristaltic pump, such that a constant volume of material is dispersed with each pulse). This hose 52 is of a length such that the main pump (P1) 24 draws the liquid composition from the tank 26, through the hose 52, and pumps it to desired destination, through a pump outflow line 60. For example, the hose 52 could range in length from approximately 1 foot to approximately 5 feet. The pump outflow line 60 terminates at a connection port (CP1) 62, to which the discharge line 30 is removably attached.

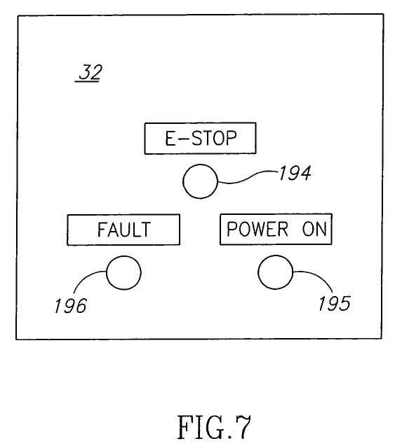

An automatic controllable valve (V₀) 64 is positioned along this outflow line 60, which is formed in part by the T-connector 65. This valve (V₀) 64 is an air powered with an electric solenoid, that directs the air, fed from line 124 (FIG. 6), to open and close the valve (V₀) 64. The solenoid for controlling the valve (V₀) 64 is electronically linked (and monitored), by wired or wireless links, to the controller (MC) 38. However, this valve (V₀) 64 is optional (and need not be part of the apparatus 20 for proper functioning), as the main pump (P1) 24, by being, for example, a peristaltic pump, is already valved, such that liquids, including liquid coloring compositions, including those described herein, water and the like, will not backflow into the main pump (P1) 24 and the pump inflow line 56.

This valve (V₀) 64 may be optionally located near the end of the outflow line 60. If located here, the flush, detailed below, would only clean out that part of the outflow line 60 and the discharge line 30 line proximate to the valve (V₀) 64.

The controller or main control (MC) 38 is electronically linked, by wired or wireless links, to the motor (M) 44 and the valve (V₀) 64, through the I/O device 35. This controller (MC) 38 functions to control the entire apparatus 20, including the motor (M) 44, in order to operate the main pump (P1) 24, as well as other components and systems of the apparatus 20, as detailed below. Throughout this document, except where specifically indicated, a component or system electronically linked to the controller (MC) 38, by wired or wireless links, is electronically linked to the controller (MC) 38 (by wired or wireless links) through the I/O device 35, that typically functions as a pass-through or relay to the PLC 36 (and accordingly, the controller (MC) 38).

There is also a sensor (S1) 66, electronically linked (wired or wireless) to the motor (M) 44, for sensing electrical behavior of the motor 44. This sensor (S1) 66 is also electronically linked (wired or wireless) to the controller (MC) 38. This sensor (S1) 66 constantly monitors the motor (M) 44 to detect discontinuous fluid flow, including interrupted fluid flow through the pump (P1) 24, typically by sensing electrical behavior in the motor, that typically corresponds to load conditions on the main pump (P1) 24. This electrical behavior can be, for example, amperage draw by the motor (M) 44, power output of the motor (M) 44, or combinations thereof. The sensor (S1) 66, sends one or more signals to the controller (MC) 38 corresponding to the particular electrical behavior being monitored, and therefore measured. Should the values for the sensed electrical behavior be at least at thresholds, as preprogrammed into the controller (MC) 38, that correspond to load conditions on the main pump (P1) 24 indicative of discontinuous fluid flow through the pump (P1) 24, including interrupted flow, that, for example, can be at least one of: a) dry running, b) cavitation, c) closed valve, d) flow variation, e) blockage, in the main pump (P1) 24, itself or on the discharge line 30 or suction side, or f) locked pump components, the controller (MC) 38 will signal the motor (M) 44 to shut off.

For example, one sensor (S1) 66 suitable for use in the apparatus is a EL-FI® M20 (EL-FI M20) Shaft Power Monitor from EMOTRON® (Emotron AB, SE-250, 24 Helsingborg, Sweden), along with its associated software. This sensor and associated software are described in the publications: 1) EMOTRON EL-FL M20 SHAFT POWER MONITOR, No. 01-2577-01 r2 EL-FL M20, and 2) EL-FI® M20 SHAFT POWER MONITOR INSTRUCTION MANUAL-Motor Shaft Output Power Measurement, Document Number: 01-2551-01, Version r2, April 2003, both publications incorporated by reference herein. This EL-FL M20 sensor monitors the motor (M) 44 and sends one or more signals, corresponding to values, typically of load conditions on the main pump (P1) 24, to the controller (MC) 38. These values may reach thresholds, programmed into the controller (MC) 38, that correspond to load conditions on the main pump (P1) 24, that for example, can be at least one of: a) dry running, b) cavitation, c) closed valve, d) flow variation, e) blockage, in the main pump (P1) 24, itself or on the discharge line 30 or suction side, or f) locked pump components. Should one or more signals, from the sensor (S1) 66, as sent to the controller (MC) 38, have reached at least a value (or values) corresponding to an improper load condition on the main pump (P1) 24, such as one of the preprogrammed values for any of the aforementioned five conditions for the pump (P1), the controller (MC) 38 will signal the motor (M) 44 to shut off.

The sensor (S1) 66 is such that an operator, for example, on a computer monitor, can view normal operating parameters of the motor (M) 44 on the job at the job site. The sensor (S1) 66 is linked by wired and/or wireless links to the motor (M) 44 and the PLC 36. The sensor (S1) 66 also sends signals to the PLC 36, and if these signals (viewable on the monitor (screen) or the like) are abnormal, typically, as preprogrammed into the system (for example, upon installation of the system 20), the sensor (S1) 66 will shut down the motor (M) 44, typically directly, but alternately, through the PLC 36. With the motor (M) 44 stopped, the main pump (P1) 24 will shut off. Default parameters may also set in the sensor (S1) 66, whereby the sensor (S1) 66 will shut down the motor (M) 44, either directly or through the PLC 36, similar to that detailed above.

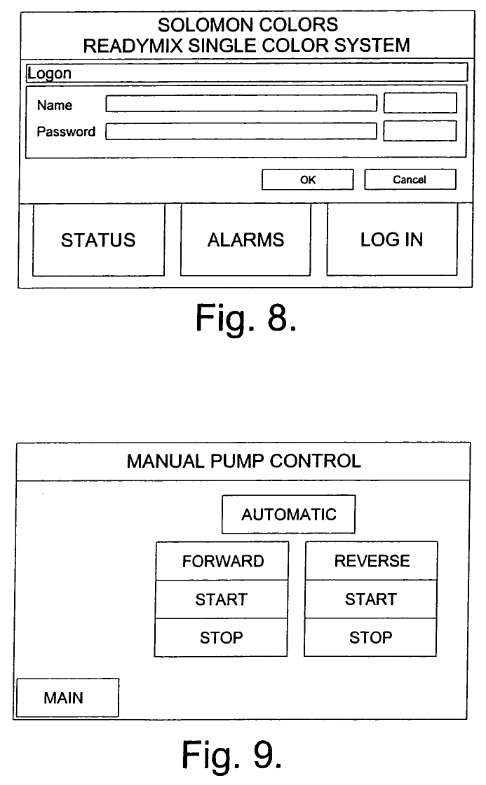

Upon motor (M) 44 shut down, the sensor (S1) 66 sends a fault signal to the PLC 36. This fault signal in the PLC 36 typically results in an audible and/or visual alarm, notifying the operator of the motor (M) 44 stoppage and pump (P1) 24 shut down. The fault can be cleared from the PLC 36, for example, through the operator's computer. For example, the operator can clear the fault by referencing a fault table, and resetting the sensor (S1) 66. Alternately, once the pump (P1) 24 is stopped, motor operating parameters may be reset to default or preprogrammed parameters and the system restarted manually by pressing the POWER ON button 197 (FIG. 7) of the control panel 32.

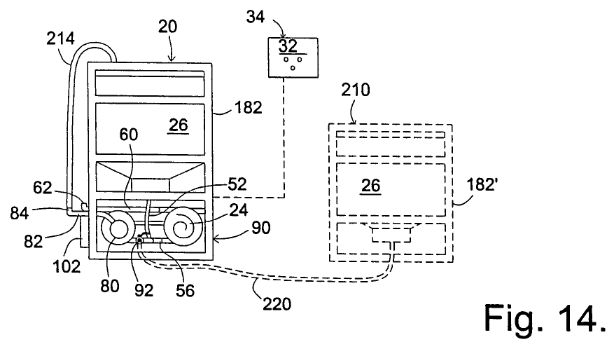

A secondary pump (P2) 80 is located in the base 40. This secondary pump (P2) 80 includes a fluid outflow line 82 extending from it, and terminating in a connection port (CP2) 84. An external line 214 (FIG. 13) can be connected to the connection port (CP2) 84, when a recirculation operation (process) is being performed, as detailed below. A fluid inflow line 86 extends into the second pump (P2) 80, from a valve (HV1) 88. This valve (HV1) 88 is optional in the apparatus 20. The valve (HV1) 88, when in the apparatus 20, is typically a two-way (two position) valve, that is hand actuated (its positioning is detailed below), but it could also be automatic, so as to be electronically linked to (by wired and/or wireless links) and controlled by the controller (MC) 38.

A fluid transport line 90 extends from the valve (HV1) 88 and terminates in a suction port (SP) 92. This suction port (SP) 92 is constructed to form temporary connections with hoses from auxiliary sources (here for example, external or auxiliary sources of liquid coloring composition), including tanks-based units, such as the auxiliary units 210 detailed herein. The liquid coloring composition from the auxiliary units 210 is then delivered by the secondary pump (P2) 80 to the tank 26 through the external line 214.

A connector line 96, extends from the valve (HV1) 88 to the T-connector 53. An automatic controllable valve (V₁) 98, is typically along the connector line 96. This valve (V₁) 98 is, for example, air powered with an electric solenoid, similar to valve (V₀) 64, detailed above. The air powered mechanism directs the air, fed from the line 124 (FIG. 6) to open and close the valve (V₁) 98. This valve (V₁) 98 is biased opposite that of the valve (V₀) 64, and is operated simultaneously with it, to activate a relay (not shown) that activates the solenoids for each valve (V₀) 64 and (V₁) 98. In their normal operating positions the valve (V₀) 64 is open, and the valve (V₁) 98 is closed. Subsequently, when the valve (V₀) 64 is closed, the valve (V₁) 98 is open. The solenoid for controlling the valve (V₁) 98 is electronically linked and monitored by wired or wireless links, to the controller (MC) 38.

The secondary pump (P2) 80 is typically an air driven pump, and is controlled by an air pressure/manifold system (AS) 100, electronically linked (wired and/or wireless) to the controller (MC) 38. The secondary pump (P2) 80, is, for example, a diaphragm pump, that is used to recirculate the liquid composition from the tank 26 (through lines 96 and 86), and back to the tank 26, through lines 82 and 214 (FIG. 13).

The air pressure/manifold system (AS) 100 is shown in detail in FIG. 6, to which attention is now directed. This system (AS) 100, typically sits in a water-tight cabinet or box 102 and includes an air line 104, from a manifold (MF) 106 (or multi-point distributor), that provides pressurized air, at pressures necessary, for example, approximately 60 pounds per square inch (psi), for driving the secondary pump (P2) 80 (so that the liquid composition can be pumped to the desired distance and/or elevation) and all regulated equipment of the apparatus 20. The manifold (MF) 106 is fed air from an air regulator 108. The air regulator 108 includes a filter and regulator unit, that filters water out of the air that enters into the regulator 108. A line 110 extends from the air regulator 108, and allows water to exit the regulator 108, by being bled out of the regulator 108.

The regulator 108 draws (plant) air from an intake port 116, through a line 118. The intake port 116 is designed to attach to an air compressor (not shown), or other source of pressurized air. The air entering the intake port 116, from compressors or other sources, is, for example, at pressures of approximately 60 pounds per square inch (psi) to approximately 120 psi.

Air sensors 120, 121 are along the line 118 and the opposite side of the air regulator 108, respectively. These air sensors 120, 121 include transducers 120a, 121a, that function to trigger faults if there is a loss of plant air, that would cause the apparatus 20 to malfunction. The first sensor 120 senses air pressure entering the regulator 108, while the second sensor 121 senses pressure of the regulated air.

The manifold 106, air regulator 108, air pressure sensors 120, 121, and their associated transducers 120a, 121a are all electronically connected, here by wired links (106c, 120c, 121c, other links not shown) to a terminal block 123. However, these components could also be connected to the terminal block 123 by wireless links. The Terminal block 123 is in turn, electronically linked, by wired or wireless links, to the controller (MC) 38.

An air line 124 extends from the regulator 108, to supply regulated air for operating the Valves (V₀) 64 and (V₁) 98. An air line 126, also known as a hand bypass line, extends from manifold (MF) 106, through the pressure sensor 121, to the secondary pump (P2) 80. A quarter turn valve (not shown) is on the line 126. This quarter turn valve can be controlled manually to operate the secondary pump (P2) 80, that will now be pumping liquid composition from the tank 26 (through lines 96 and 86) and out of the apparatus 20 through the connection port (CP2) 84, through line 82, typically into buckets or other receiving devices. Use of the secondary pump (P2) 80 in this manner is a back up, to be used only in cases where the automatic systems of the apparatus 20 fail.

A water system (WS) 130 is also in the cabinet 102. The water system (WS) 130 includes a water pressure sensor 131 and a valve (V_{S}) 132, associated with the sensor 131. The water pressure sensor 131 receives water from the transport line 164, that enters the cabinet 102 from the rear. The transport line 164 extends through this cabinet 102 and terminates at the T-connector 65. The valve (V_{S}) 132 opens when it is desired to release the water in this supply line 164 (and also the water stored in the pressure tank 162) to flush the outflow line 60 and the discharge line 30. The complete flush operation of this water system 130 is further detailed below.

A heater (H) 135 is in the cabinet 102, so that the aforementioned air system (AS) 100 components and water system (WS) 130 components, including the supply line 164, can function properly and are not subjected to freezing temperatures, that can cause these components to malfunction. The heater (H) 135 is wired to a transformer (not shown), that powers it (the heater (H) 135 includes its own thermostat). The water 20 pressure sensor 131, and sensor valve (V_{S}) 132 are all electronically connected to the terminal block 123 (here, by wired links, with only wire link 132c shown, although wireless links are also permissible), that is in turn electronically linked, by wired or wireless links, to the controller (MC) 38.

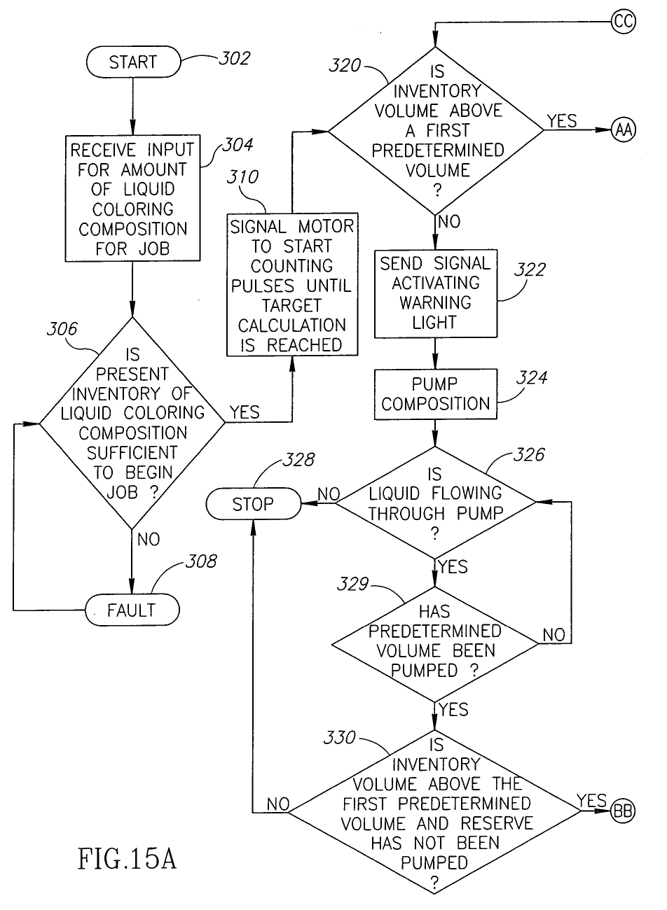

The aforementioned two positions for the valve (HV1) 88, will now be described. In the first, and most common or default position, the valve (HV1) 88 is closed to the suction port (SP) 92 (closing the line 90), and open to the connector line 96, and the inflow line 86. The valve (V₁) 98, if in the apparatus 20, is also open. As a result, there is a pathway for liquid composition, from the tank 26 to the secondary pump (P2) 80, through the hose 52, and lines 96 and 86. The secondary pump (P2) 80 is now accessible, and upon its activation, will draw liquid composition from the tank 26 and send it back to the tank 26 through the outflow line 82, and an external line 220 (FIG. 14). The external line 214 connects to the apparatus 20 at the connection port (CP2) 84, and terminates at the tank 26. This first position for the valve (HV1) 88 allows for recirculation of the liquid composition in the tank 26, as described below.

In a second position, the valve (HV1) 88 is open to the suction port (SP) 92, line 90, and line 86, providing a pathway from the suction port 92 to the secondary pump (P2) 80. The valve (HV1) 88 is closed to the connector line 96, and for safety and redundancy, and the valve (V₁) 98 would normally be closed (but does not have to be). An auxiliary unit 210 with liquid coloring composition or other source of liquid coloring composition, can be brought along side (or lateral) to the apparatus 20, as shown in FIG. 14. A line 220 can be connected from the tank 26 of the auxiliary unit 210, to the suction port (SP) 92. The secondary pump (P2) 80, upon activation, will draw liquid composition from the tank 26 of the auxiliary unit 210, and send it back to the tank 26 through the outflow line 82, and an external line 214. The external line 214 connects to the apparatus 20 at the connection port (CP2) 84, and terminates at the tank 26, allowing for recirculation of liquid composition, prior to its being pumped from the tank 26 of the apparatus 20.

A system for flushing a portion of the outflow line 60 and discharge line 30 (if joined to the outflow line 60) (also known as the flush system) is in the base 40, as part of the apparatus 20. The flush system includes a supply line 160, a pressure or bladder tank 162 and a transport line 164, for transporting fluid, typically water, at pressures sufficient to flush liquid composition or remnants thereof from the aforementioned portion of the outflow line 60 and the discharge line 30 (if joined to the outflow line 60), for example, into the mixing chamber 28 of the ready mix truck 22 (FIG. 1).

The supply line 160 receives fluid, typically water, from a municipal or other source, here, for example, indicated on FIG. 2 as “CITY WATER”. A one-way valve, typically a check valve (CV) 168, for example, a spring loaded ball valve, is along the supply line 160, as is a regulator (R) 170. The supply line 160 includes a T-connector 171, between the regulator (R) 170 and the bladder tank 162. The supply line 160 terminates at the bladder tank 162, and the transport line 164 originates at the T-connector 171.

The municipal water is normally of a pressure that is sufficient to force the check valve (CV) 168 open. The municipal water then travels in the supply line 160, through the regulator (R) 170 at sufficient pressures to flush the outflow line 60 and the discharge line 30 (when it travels through the transport line 164, upon moving through the T-connector 171). The pressure of the municipal water is such that it flows through the supply line 160, through the T-connector 171, and into the bladder tank 162, filling it. Once the bladder tank 162 filled, backpressure from the water in the line 160, between the T-connector 171 and the bladder tank 162 forces the water to flow through the transport line 164, where its flow is controlled by the sensor valve (V_{S}) 132 (FIG. 6), prior to its release into the remainder of the transport line 164 (downstream of the sensor valve (V_{S}) 132).

The bladder tank 162 is a passive back up to municipal water, and will flush the apparatus 20, when the municipal water pressure is too low to flush the apparatus 20. The bladder tank 162 supplies water (as received through the supply line 160), either alone or coupled with municipal water entering the flush system (through line 160), for flushing the apparatus 20.

In operation, the bladder tank 162 is such that it empties when municipal water pressure is lost or too low, for example, at pressures to low to open the check valve (CV) 168, either partially or at all. Accordingly, during these conditions, when the water pressure from the municipal source in the line becomes less then the pressure of the water in the bladder tank 162, the bladder in the bladder tank 162 forces flush water out of the tank 162. The water exits the bladder tank and flows toward the sensor valve (V_{S}) 132 (FIG. 6), as it can not flow out of the line 160, as the check valve 168 is one-way and closed (preventing backflow of water in the supply line 160, into the municipal system). As a result, the rubberized air-actuated bladder or air bladder in the tank 162 drives the water, from the supply line 160, through the T-connector 171, into the transport line 164. With the sensor valve (V_{S}) 132 open, the water flows through the remainder of the transport line 164 at sufficient pressures to flush the outflow line 60 and discharge line 30.

The bladder tank 162 is typically a metal tank, for handling fluid, water pressures of approximately 20-50 pounds per square inch (psi). For example, pressures of approximately 20-30 psi are typical in the tank 162. By having a pressurized bladder tank 162 for driving the flush water, the apparatus 20 is not dependent on the municipal water system, and its pressures for the flush operation. The transport line 164 is, for example, a hose of a material sufficient to withstand fluid pressures of up to approximately 120 psi.

The regulator (R) 170 serves to control water pressure in the tank 162, that drives the water (or fluid) in the transport line 164. For example, the regulator (R) 170, functions to regulate pressures from approximately 20-70 psi and typically, approximately 50 psi. The regulator (R) 170 is typically a mechanical device.

The transport line 164 extends from the T-connector 171, through the cabinet 102, to the T-connector 65 of the outflow line 60. The water pressure sensor 131 and sensor valve (V_{S}) 132 are on this transport line 164, as detailed above. A one-way or check valve (CV) 172, similar to the check valve (CV) 168 is along this transport line 164, allows flush water to pass therethrough, and prevent liquid composition, typically liquid coloring composition, from entering the transport line 164. The check valve (CV) 172 is typically proximate to the T-connector 65.

During a flush operation or flush, valve (V_{S}) 132 is opened to the requisite size, by the controller (MC) 38, typically based on timing, for example, approximately 20 second periods. Flushing is typically from municipal water pressure, but could be from the bladder tank 162, as detailed above. The Valve (V₀) 64, if present in the apparatus 20, is closed. The flush water must be of a sufficient pressure, as it flows through the transport line 164, for flushing the outflow line 60 (and the discharge line 30 if attached). If not of sufficient pressure, for example, at least 20 psi, flush water will not have sufficient pressure for the aforementioned flush. If the valve (V₀) 64 is not present in the apparatus 20, the main pump (P1) 24 itself, by virtue of it typically being a peristaltic pump, serves as a valve, such that flush water will not reach the inflow line 56.

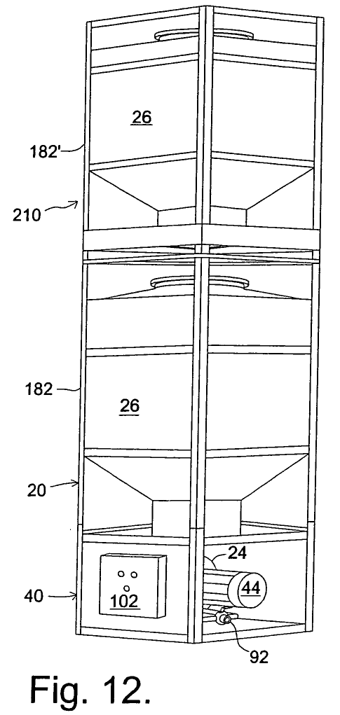

The tank 26 or tote is typically a plastic, stainless steel or other suitable material container or vessel, that is both water and chemical resistant, where the liquid composition is stored. The tank 26 is typically of a volume of, for example, approximately 400 gallons. It is held in a frame 182. For example, the tank 26 can be a Poly V Bottom Tank, Stock No. T-400, available from Granger Plastics of Middletown, Ohio. The frame 182 is such that it can be fit over the base 40 in a sturdy manner, so that an auxiliary unit, for example, unit 210 of FIG. 12 (with a tank 26 held in a frame 182′), can be stacked over the frame 182 of the apparatus 20.

A sensor (S2) 184, includes a detector 184a, that is positioned on the side of the tank 26. This sensor (S2) 184 is a liquid level sensor, typically a capacitive sensor, including the detector 184a (connected to the rest of the sensor 184 by wired and/or wireless links, as shown by the broken line connecting these elements), designed to sense the presence of product (i.e., liquid coloring composition) in the tank 26. The sensor (S2) 184 may be, for example a capacitive sensor from Turk Manufacturing. The sensor (S2) 184 is electrically linked, by wired or wireless links, to the controller (MC) 38. It may also be electronically linked directly to the motor (M) 44.

The sensor (S2) 184 constantly monitors the level of the liquid composition, and when it sends signals corresponding to a threshold depth for the liquid (corresponding to a low volume of liquid composition remaining in the tank 26, for example, approximately 100 gallons remaining), the controller (MC) 38 is programmed to stop further activation and shut off the motor (M) 44 (stopping the pump (P1) 24. Shutting off the motor (M) 44 at this low liquid level, while liquid coloring composition is still in the tank 26, ensures that pumping of liquid coloring composition has been continuous and uninterrupted.

Alternately, a sensor may be placed on the upper rim 186 of the tank 26 in a bung 187. This alternate sensor would be connected to the main controller (MC) 38 and motor (M) 44 as described for the sensor (S2) 184 above, and it would be a depth sensor or liquid level sensor, and, for example, an ultrasonic sensor. This alternate sensor would function by measuring the level of the liquid composition in the tank 26, the depth of the liquid composition corresponding to the volume of the liquid composition in the tank 26.

The controller (MC) 38 is typically processor based, and, for example, can be formed of one or more microprocessors (e.g., Pentium® processors). The controller (MC) 38 is able to process inputs from multiple sources, to monitor performance and send outputs to activate the valves, motors, and other components of the apparatus 20 detailed herein. The controller (MC) 38 is programmable in order to accommodate thresholds for load conditions on the main pump (P1) 24 (as detailed above), and liquid composition levels in the tank 26, as monitored, as well as air and water pressures (from the respective air 100 and water 130 systems).

Turning to FIG. 7, the control panel 32 typically includes a primary power disconnect switch 194, that may be activated when various situations arise, and indicator lights 195, 196. The indicator lights 195, 196 are for POWER ON and FAULT, respectively, and illuminate when the apparatus 20 is under one of these conditions.

The disconnect switch 194, indicated by E-STOP is a button or the like that, when activated, can also be used to hold or halt dispensing of liquid coloring composition into a batch of concrete. Activating this button will allow the operator to determine if a problem is resolved. If the problem is resolved, the disconnect switch 194 can be deactivated (by being pressed or the like), and the apparatus resumes dispensing of the liquid coloring composition. Alternately, the operator can terminate the batching sequence, to minimize loss of product.

The Ethernet connection 37 (FIG. 2), for example, a cable or other wired or wireless link, provides a linkage to the controller (MC) 38, such that the apparatus 20 can be controlled and maintained from locations ranging from on site, proximate to the apparatus 20, to remote locations, in the same city or anywhere in the world where telecommunications are possible. The PLC 36 typically includes a computer or a touch screen device, allowing the operator total control over the apparatus 20, from remote locations.

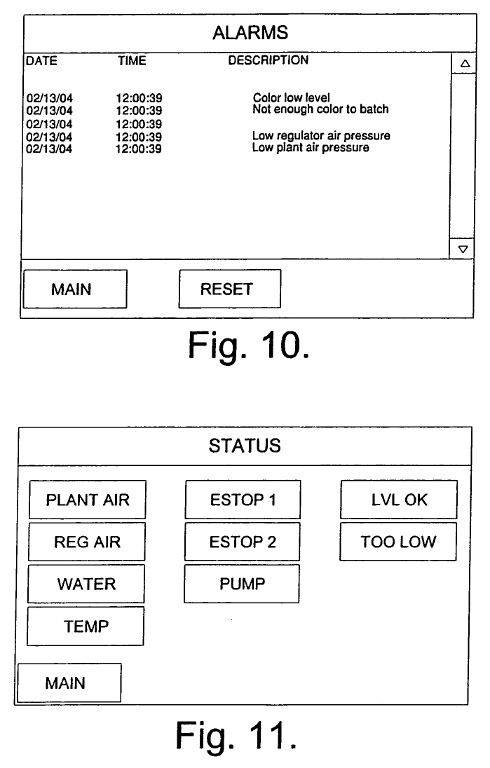

For example, the PLC 36 may be such that various screens will appear that the operator (user) can control. Sample screens are shown in FIGS. 8-11, to which attention is now directed. In FIG. 8, there is an introductory screen, where a user enters his name and password to begin the operation. From this introductory screen, the status of the pumping process can be viewed as well as any alarms.

In FIG. 9, there is a screen that will allow the user to control the main pump (P1) 24 manually, and also place the main pump (P1) 24 into an automatic mode. FIG. 10 is a screen of alarms, while FIG. 11 is a screen indicating the status for the entire apparatus 20, with blocks for the air pressure, water pressure, the main pump (P1) 24 and liquid levels in the tank 26.

Exemplary operations of the apparatus will now be described. In describing these operations, references will be made to FIGS. 1-11 above, as well as other figures as indicated.

As shown in FIG. 1, a liquid coloring composition, for example, for cementicious material, such as concrete, cement or the like, is being delivered from the apparatus 20 to a mixing chamber. Here, the mixing chamber 28 is in a ready mix truck 22 for concrete. The liquid coloring composition is in the tank 26, and it is drawn by the main pump (P1) 24 through the hose 52. The main pump (P1) 24, for example, a peristaltic pump, generates a sufficient pumping force such that the liquid coloring composition is delivered to the mixing chamber 28 of the ready mix truck 22, over distances, for example, of approximately 25 to 100 feet, and at elevations above the discharge point of the apparatus 20. A path for the liquid coloring composition from the tank 26 to the main pump (P1) 24, through the hose 52, is created as the valve (V₁) 98 on the connector line 96 is closed (preventing the flow of liquid composition into the connector line 96).

The motor (M) 44 is typically continuously monitored by the sensor (S1) 66. Should the sensor (S1) 66 send a signal or signals to the controller (MC) 38, corresponding to at least a value that has been preprogrammed into the controller (MC) 38, corresponding to electrical behavior indicative of an improper load condition in the main pump (P1) 24, such that liquid coloring composition is no longer being pumped (flow of the liquid coloring composition is not continuous), the controller (MC) 38 will signal the motor (M) 44 to shut off. Upon this shut off, the main pump (P1) 24 will cease operation immediately, and typically, will not restart until restarted by the operator. For example, when this condition occurs, the FAULT light 196 will illuminate on the control panel 32, or on a screen of the PLC 36 (FIG. 11) the icon “PUMP”, warning the operator or attendant (user) that the apparatus 20 has ceased pumping liquid coloring composition.

Additionally, the sensor (S2) 184 (including the detector 184a on the tank 26) constantly monitors the level (depth) of the liquid coloring composition in the tank 26. When the controller (MC) 38 receives a signal from the sensor (S2) 184, that at predetermined or threshold level for the liquid composition has been reached, this level corresponding to a threshold volume of liquid composition remaining in the tank 26, as programmed into the controller (MC) 38, the controller (MC) 38 signals the motor (M) 44 to complete the batch for the mixing chamber, and then shut off. This threshold level is programmed into the controller (MC) 38, such that once batched out (distributed or pumped out of the tank 26), there is still liquid composition in the tank 26. Upon this shut off, the main pump (P1) 24 will cease operation immediately, and typically, will not restart until restarted by the operator (who can not restart the apparatus 20 until additional liquid composition has been added to the tank 26).

For example, when this condition occurs, the FAULT light 196 will illuminate on the control panel 32, or on a screen of the PLC 38 (FIG. 11), through the icons “TOO LOW” and “PUMP”, warning the operator or attendant (user) that the apparatus 20 will cease pumping liquid coloring composition, once this batch is dispensed, due to the level in the tank 26 reaching a threshold level. This threshold level is typically preprogrammed into the controller (MC) 38, such that liquid composition remains in the tank 26, so that until the time of shut off of the main pump (P1) 24, liquid composition was continuously pumped without interruption.

Alternately, the controller (MC) 38 can be programmed such that when a level before the programmed threshold level is reached, the PLC 36 can have a screen icon that the level is getting low and liquid coloring composition must be added, typically to the tank 26. This can be done by adding liquid coloring composition to the tank 26 manually, through buckets, hoses or the like. Alternately, as shown in FIG. 12, additional liquid coloring composition can be obtained for placement into the tank 26 of the apparatus 20, by stacking an auxiliary unit 210 (tank 26 and frame 182′) on top of the apparatus 20, and opening the tank 26 of the auxiliary unit 210, such that its liquid coloring composition empties into the tank 26 of the apparatus 20 (the top of this tank 26 is either open or was opened to receive the liquid coloring composition from the tank 26 of the auxiliary unit 210).

FIG. 13 shows the apparatus 20 performing a recirculation operation or process (known also as recirculation). Recirculation operations are typically performed prior to pumping the liquid coloring composition from the main pump (P1) 24 to the destination. Recirculation is performed by the secondary pump (P2) 80, that is, for example, a diaphragm pump.

Recirculation typically reduces the viscosity of the liquid coloring composition, that typically increases in viscosity as it sits in the tank 26 during periods of storage. By recirculating the liquid coloring composition back to the tank 26, its viscosity is reduced and it becomes more flowable, such that it can easily be drawn by the main pump (P1) 24, for its delivery to the desired destination. Recirculation, prior to pumping through the main pump (P1) 24 to the desired destination, is desirable when a liquid coloring composition such as CF 413 Red, from Solomon Colors, Inc., Springfield, Ill., is being used in the apparatus 20.

Recirculation begins as an external line 214 is connected to the apparatus 20 at the connection port (CP2) 84. The valve (V₁) 98 is opened, and the valve (HV1) 88 is positioned such that a pathway is established from the tank 26, through the hose 52, through the connector line 96, through the fluid inflow line 86 to the secondary pump (P2) 80. As this secondary pump (P2) 80 is, for example, a diaphragm pump, it receives pressurized air from the manifold (MF) 106, to drive the liquid coloring composition, drawn into the secondary pump (P2) 80. Once pumped, the liquid composition is expelled from the secondary pump (P2) through the outflow line 82, then through the external line 214, and into the tank 26. The now recirculated liquid coloring composition can be again recirculated by the aforementioned recirculation operation or process, or delivered to the desired destination by the main pump (P1) 24, as detailed above. As pumping of the secondary pump (P2) 80 is controlled by the controller (MC) 38, the recirculation operation can be automatic and controlled through the controller (MC) 38 by either activating a button or the like on the control panel 32 or activating an icon on the PLC 36.

Alternately, as shown in FIG. 14, an auxiliary unit 210 can be brought along side of (lateral to) the apparatus 20. The liquid coloring composition of the tank 26 of this auxiliary unit 210 can be obtained by extending a line 220 from this tank 26 to the suction port (SP) 92 of the apparatus 20. A path for the liquid coloring composition from the tank 26 of the auxiliary unit 210 to the secondary pump (P2) 80 is created by adjusting the valve (HV1) 88 to open, for color to flow through the fluid transport line 90, and the inflow line 86, and closing the valve (V₁) 98. A second external line 214 is connected at the connection port 84 of the outflow line 82. The secondary pump (P2) 80 is now activated. The secondary pump (P2) 80 draws liquid coloring composition from the tank 26 of the auxiliary unit 210, and fills the tank 26 of the apparatus 20. This results in a recirculation of the liquid coloring composition, as drawn from an auxiliary source. Once the tank 26 of the apparatus 20 has been filled with recirculated liquid composition, similar to the recirculation detailed in FIG. 13, the liquid coloring composition in the tank 26 of the apparatus 20 can be pumped to the desired mixing unit, such as that shown and described for FIG. 1.

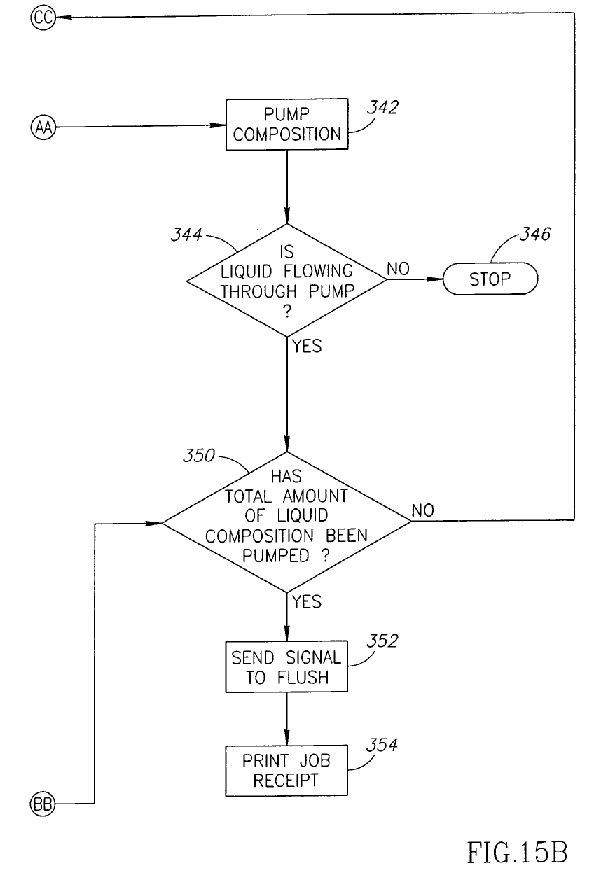

FIGS. 15A and 15B are a flow diagram of a process performed by the apparatus 20. This process is typically controlled by the PLC 36. The process can be performed by hardware, software or combinations of hardware and software.

The process begins with a START, at block 302. At block 304, input is received from an operator, as to the amount of liquid coloring composition needed for the specific job. This input typically includes the volume of the liquid coloring composition needed to be added (dispensed by the apparatus 20) to the batch of concrete. The batch of concrete corresponds to the number of yards that will be poured, so that all batches of concrete for a particular job will be uniform in color. This input also includes a truck number/ticket number.

Once the apparatus is activated, typically by pressing the START on the control panel, or from the PLC 36. The PLC 36 will then check the inventory level of the liquid composition in the tank 26, from a reading by the sensor (S2) 184, prior to starting, at block 306. The inventory level is checked to see if there is sufficient inventory to allow for proper dispersing. If the inventory level is too low, for example, 100 gallons or less (at the corresponding liquid level will be below the detector 184a of the sensor (S2) 184, such that liquid composition is not detected), the apparatus 20 will indicate a fault, at block 306. indicating to the operator that liquid coloring composition must be added to the tank 26, so that pumping (and ultimately delivery) can begin. Should a sufficient amount of liquid composition be added to the tank 26, the process returns to block 306.

Alternately, if the inventory level is above this 100 gallon threshold, the motor (M) 44 is activated and pulses are counted until the target number of pulses is reached, corresponding to the exact amount of liquid coloring composition to be dispensed to that particular batch of concrete, at block 310. By dispensing exact amounts of liquid coloring composition, the coloring of each batch for a particular job will be uniform. The volume of liquid coloring composition dispensed by each pulse is typically determined by calibrating the main pump (P1) 24 of the apparatus 20. This can be done, for example, by running the main pump (P1) 24 for 120 pulses, and weighing the resultant dispersed material. The weight corresponds to a volume, such that the volume emitted from one pulse can be determined. This volume per single pulse can then be entered into the PLC 36.

The process moves to block 320, where inventory level in the tank 26 is again checked by the sensor (S2) 184. If the inventory level has fallen below the position of the detector 184a of the sensor (S2) 184 (for example, corresponding to approximately 100 gallons in the tank 26), the sensor (S2) 184, sends a signal to the PLC 36, and to the control panel 32, activating a warning light at block 322.

The main pump (P1) 24 is now active, at block 324, and a reading is then taken from the motor sensor (S1) 66 if liquid is flowing through the pump (P1) 24, at block 326. If liquid is not flowing through the main pump (P1) 24, the PLC 36 signals the main pump (P1) 24 to stop, at block 328.

If liquid is flowing through the pump (P1) 24, the program in the main controller (MC) 38, via pulses, will allow the motor (M) 44 and the pump 24 to pump a predetermined volume of liquid, for example 3-4 reserve batches (or reserve) (each batch, for example, 15 gallons) of liquid colorant prior to shutting down the motor (M) 44 and the main pump (P1) 24. At block 329, it is determined if this predetermined amount has been pumped. If this predetermined volume has not been pumped, the process returns to block 326. However, if the predetermined volume has been pumped, and liquid composition is added during the period when these 3-4 reserve batches (or reserve) are being pumped, it is determined if the liquid level is above the detector 184a of the sensor (S2) 184, at block 330. This warning light allows batching (and pumping) to continue while liquid composition is being transferred to the tank 26.

At block 330, the inventory in the tank 26 is again checked to see if it is above the first predetermined volume, for example, approximately 100 gallons, and the reserve batches (reserve) have been pumped. If the inventory volume is below the first predetermined volume, for example, approximately 100 gallons (and the reserve has been pumped) the process stops, at block 328. If the inventory volume is above the first predetermined volume, the process moves to block 350.

At block 350, it is determined if the total amount of liquid composition entered into the PLC 36 has been pumped. If not, the process returns to block 320, and continues from this block. If the total amount of liquid composition has been pumped, the PLC signals the water system (WS) 130 to open the valve (V_{S}) 132, and the air system (AS) 100 to close the valve (V₀) 64 to begin the flush operation, at block 352. This flush operation is typically timed, and will flush any remaining composition in the outflow 60 and discharge 30 lines into the mixing chamber 28 of the truck 22. This flush period is, for example, approximately 20 seconds. Once the timed period is over, the valve (V_{S}) 132 closes, and the valve (V₀) 64 opens. With the flush complete, the process moves to block 354, where a job receipt is printed for the truck 22 (FIG. 1). This receipt is stored in the PLC 36. The receipt typically includes, yards of concrete treated, amount (volume) of liquid coloring composition for the batch, date and time, truck number, job name and color.

All batch records and faults of the apparatus 20 are retained on a flash back-up card, as taken from the PLC 36. This allows these records to be reviewed at a later date if necessary.

Returning to block 320, the inventory volume is above the first predetermined volume, such that the pump is now active, at block 342 (similar to block 324), and a reading is then taken from the motor sensor (S1) 66, if liquid is flowing through the main pump (P1) 24, at block 344 (similar to block 326). If liquid is not flowing through the main pump (P1) 24, the PLC 36 signals the main pump (P1) 24 to stop, at block 346.

If liquid is flowing through the pump, the process moves to block 350, as described above.

The process can be repeated for as many ready mix trucks as desired.

The above described process of the flow diagram of FIGS. 15A and 15B, including portions thereof, can be performed by software, hardware and combinations thereof. These processes and portions thereof can be performed by computers, computer-type devices, workstations, processors, micro-processors, other electronic searching tools and memory and other storage-type devices associated therewith. The process and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The process and system on which it is performed, including components thereof, have been described with exemplary reference to specific hardware and software. The process has been described as exemplary, whereby specific steps and their order can be omitted and/or changed by persons of ordinary skill in the art to reduce these embodiments to practice without undue experimentation. The process and system have been described in a manner sufficient to enable persons of ordinary skill in the art to readily adapt other hardware and software as may be needed to reduce any of the embodiments to practice without undue experimentation and using conventional techniques.

While the apparatus 20 has been shown for delivering liquid coloring composition, this is exemplary only. The apparatus 20 is suitable for delivering any kind of liquid or liquid composition to any desired mixture of components at any desired destination.

There have been shown and described preferred embodiments of liquid composition delivering apparatus and methods for their use. It is apparent to those skilled in the art, however, that many changes, variations, modifications, and other uses and applications for the apparatus, its components, and methods for its use are possible, and also such changes, variations, modifications, and other uses and applications which do not depart from the spirit and scope of the invention are deemed to be covered by the invention, which is limited only by the claims which follow.

What is claimed is:

1. A method for delivering colorant to concrete, to produce uniformly colored concrete batches, comprising:
obtaining liquid coloring composition from at least one source of coloring composition;
determining the amount of the liquid coloring composition for uniformly coloring at least one batch of concrete with respect to at least one other batch of colored concrete;
delivering the liquid coloring composition into a mixing chamber for mixing and coloring at least one batch of concrete in the mixing chamber, including pumping the liquid coloring composition into the mixing chamber along a flow pathway from the at least one source to the mixing chamber; and,
monitoring the delivering of the liquid coloring composition such that the amount of liquid coloring composition delivered is at least substantially equal to the determined amount of liquid coloring composition.

2. The method of claim 1, wherein the pumping the liquid coloring composition includes pumping the liquid coloring composition for a predetermined number of pulses corresponding to the determined amount of liquid coloring composition.

3. The method of claim 1, wherein monitoring the delivering of the liquid coloring composition includes monitoring along the flow pathway to determine if the liquid coloring composition is being delivered continuously.

4. The method of claim 3, wherein monitoring along the flow pathway includes monitoring the load on the motor of a first pump that is pumping the liquid coloring composition to the mixing chamber.

5. The method of claim 1, wherein monitoring the delivering of the liquid coloring composition includes monitoring the at least one source of the liquid coloring composition to determine if there is a sufficient amount of liquid coloring composition in the at least one source such that the determined amount of liquid coloring composition can be delivered from the at least one source.

6. The method of claim 4, additionally comprising: stopping the delivering of the liquid coloring composition if load on the motor determined by the monitoring is of a value corresponding to the liquid coloring composition not being delivered continuously.

7. The method of claim 6, wherein stopping the delivering of the liquid coloring composition includes stopping the first pump that is pumping the liquid coloring composition.

8. The method of claim 5, wherein the at least one source includes a tank of the liquid coloring composition.

9. The method of claim 8, wherein the monitoring the delivering of the liquid coloring composition includes sensing the volume of the liquid coloring composition in the tank.

10. The method of claim 9, additionally comprising, signaling the first pump to stop pumping if the volume of the liquid coloring composition in the tank falls below a predetermined volume.

11. The method of claim 1, wherein the liquid coloring composition is selected from the group consisting of: coloring agents, pigments, and other colorants.

12. The method of claim 4, wherein the first pump includes a peristaltic pump.

13. The method of claim 1, additionally comprising, recirculating the liquid composition from the at least one source back to the at least one source.

14. The method of claim 13, wherein the recirculating the liquid coloring composition occurs prior to delivering the liquid coloring composition into the mixing chamber.

15. The method of claim 14, wherein the recirculating the liquid coloring composition includes, providing a second pump and drawing the liquid composition from the at least one source into the second pump and pumping the liquid composition into the at least one source.

16. The method of claim 15, wherein the second pump includes a diaphragm pump.

17. A method for delivering colorant to concrete comprising:
obtaining at least a predetermined amount of liquid coloring composition, the predetermined amount of liquid coloring composition for uniformly coloring at least one batch of concrete with respect to at least one other batch of colored concrete;
delivering the liquid coloring composition into a mixing chamber for mixing with a batch of concrete, including providing a first pump for pumping the liquid coloring composition; and,
monitoring the first pump to determine if the delivering of the liquid coloring composition is continuous.

18. The method of claim 17, wherein the monitoring the first pump includes monitoring the load on the motor of the first pump that is pumping the liquid coloring composition to the mixing chamber.

19. The method of claim 18, additionally comprising: stopping the motor of the first pump if the load on the motor has reached at least a threshold corresponding to liquid coloring composition not being delivered continuously through the pump.

20. The method of claim 17, additionally comprising: providing at least one source for the liquid coloring composition, and obtaining at least a predetermined amount of liquid coloring composition includes obtaining at least a predetermined amount of liquid coloring composition from the at least one source.

21. The method of claim 20, wherein the at least one source includes a tank of liquid coloring composition.

22. The method of claim 21, additionally comprising: monitoring the volume of the liquid coloring composition in the tank.

23. The method of claim 22, wherein monitoring the volume of the liquid coloring composition includes sensing the volume of the liquid coloring composition in the tank and if the volume has fallen to at least a predetermined volume, signaling the first pump to cease operation.

24. The method of claim 17, wherein the liquid coloring composition is selected from the group consisting of: coloring agents, pigments, and other colorants.

25. The method of claim 20, additionally comprising, recirculating the liquid composition from the at least one source back to the at least one source.

26. The method of claim 25, wherein the recirculating the liquid coloring composition occurs prior to delivering the liquid coloring composition into the mixing chamber.

27. The method of claim 26, wherein the recirculating the liquid coloring composition includes, providing a second pump and drawing the liquid composition from the at least one source into the second pump and pumping the liquid composition into the at least one source.

28. The method of claim 17, wherein the first pump includes a peristaltic pump.

29. The method of claim 27, wherein the second pump includes a diaphragm pump.

30. An apparatus for delivering a liquid composition to a predetermined site comprising:
a first pump configured for drawing liquid composition from a source of liquid composition and pumping the liquid composition along a flow pathway from a source of liquid composition to a discharge opening, the first pump including a motor;
a controller in electrical communication with the motor of the first pump, the controller configured for controlling operation of the motor of the first pump; and,
at least one first sensor configured for sensing the flow of liquid composition along the flow pathway, the at least one first sensor in electrical communication with the motor and the controller.

31. The apparatus of claim 30, wherein the at least one first sensor is configured for sensing load on the motor of the first pump.

32. The apparatus of claim 31, wherein the at least one first sensor is configured for signaling the controller to stop operation of the motor when the load sensed on the motor of the first pump reaches at least a threshold value corresponding to liquid composition not flowing continuously through the pump.

33. The apparatus of claim 30, wherein the first pump includes a peristaltic pump.

34. The apparatus of claim 30, additionally comprising: a tank in communication with the first pump.

35. The apparatus of claim 34, wherein the tank includes a liquid composition to define a source of liquid composition.

36. The apparatus of claim 34, additionally comprising at least one second sensor configured for detecting the volume of the liquid composition in the tank, the at least one second sensor in electrical communication with the controller.

37. The apparatus of claim 36, wherein the at least one second sensor includes a liquid level sensor.

38. The apparatus of claim 36, wherein the controller is configured to stop operation of the motor when the signals received from the at least one second sensor correspond to the volume of the liquid composition in the tank falling to at least a threshold volume.

39. The apparatus of claim 34, additionally comprising: at least one second pump in communication with the tank, the at least one second pump configured for drawing liquid composition from the tank and pumping it back to the tank.

40. The apparatus of claim 39, wherein the at least one second pump includes a diaphragm pump.

41. The apparatus of claim 30, wherein the controller is configured for controlling operation of the motor of the first pump to pump a predetermined amount of liquid composition from a source of liquid composition.

42. An apparatus for delivering a liquid composition to a predetermined site comprising:
a vessel for holding liquid composition;
a first pump in communication with the vessel, the first pump for drawing liquid composition from the vessel and pumping the liquid composition along a flow pathway from the vessel to a predetermined location, the first pump including a motor;
a controller in electrical communication with the motor of the first pump; and,
at least one first sensor configured for sensing the flow of liquid composition along the flow pathway, the at least one first sensor in electrical communication with the motor and the controller.

43. The apparatus of claim 42, wherein the controller is configured for controlling operation of the motor of the first pump to pump a predetermined amount of liquid composition from the vessel.

44. The apparatus of claim 42, wherein the at least one first sensor is configured for sensing load on the motor of the first pump.

45. The apparatus of claim 44, wherein the at least one first sensor is configured for signaling the controller to stop operation of the motor when the load sensed on the motor of the first pump reaches at least a threshold value corresponding to liquid not flowing continuously through the pump.

46. The apparatus of claim 42, wherein the first pump includes a peristaltic pump.

47. The apparatus of claim 42, wherein the vessel includes a tank.

48. The apparatus of claim 42, additionally comprising at least one second sensor configured for detecting the volume of the liquid composition in the vessel, the at least one second sensor in electrical communication with the controller.

49. The apparatus of claim 48, wherein the at least one second sensor includes a liquid level sensor.

50. The apparatus of claim 48, wherein the controller is configured to stop operation of the motor when the signals received from the at least one second sensor correspond to the volume of the liquid composition in the vessel falling to at least a threshold volume.

51. The apparatus of claim 42, additionally comprising: at least one second pump in communication with the vessel, the at least one second pump configured for drawing liquid composition from the vessel and pumping it back to the vessel.

52. The apparatus of claim 51, wherein the at least one second pump includes a diaphragm pump.

53. An apparatus for delivering a liquid composition to a predetermined site comprising:
at least one first pump including a motor;
a tank in communication with the at least one first pump;
a controller in electrical communication with the motor, the controller configured for controlling operation of the motor; and,
at least one first sensor configured for sensing liquid volume in the tank, the at least one first sensor in electrical communication with the motor and the controller.

54. The apparatus of claim 53, wherein the at least one first sensor includes a liquid level sensor.

55. The apparatus of claim 53, wherein the controller is configured for receiving signals from the at least first one sensor corresponding to liquid volumes in the tank, and controlling the motor in response to the signals.

56. The apparatus of claim 55, wherein the controller configured for controlling the motor includes stopping operation of the motor when the signals received from the at least one first sensor correspond to the liquid volume in the tank falling to at least a threshold volume.

57. The apparatus of claim 53, wherein the first pump includes a peristaltic pump.

58. The apparatus of claim 53, additionally comprising: at least one second pump in communication with the tank, the at least one second pump configured for drawing liquid composition from the tank and pumping it back to the tank.

59. The apparatus of claim 58, wherein the at least one second pump includes a diaphragm pump.
